(19) United States
(12) Patent Application Publication
(10) Pub. No.: US 2010/0156660 A1
(43) Pub. Date: Jun. 24, 2010

(54) APPARATUS AND METHOD FOR ESTIMATING POSITION OF MOBILE UNIT

(76) Inventors: In Ock LEE, SEOUL (KR); Jo Cheol JIN, YONGIN-SI (KR)

Correspondence Address: IPLA P.A., 3550 WILSHIRE BLVD., 17TH FLOOR, LOS ANGELES, CA, 90010, US

(21) Appl. No.: 12/437,499

(22) Filed: May 7, 2009

(30) Foreign Application Priority Data
Dec. 23, 2008 (KR) 10-2008-0132320

(51) Int. Cl. G08B 5/22; H04Q 5/22

(52) U.S. Cl. 340/825.49; 340/10.4

(57) ABSTRACT

Provided is a tag attached to a mobile unit to estimate a position of the mobile unit, which can minimize the estimation position error of a mobile unit even while increasing the positioning interval of a beacon, and the tag includes a radio frequency (RF) transceiver transmitting and receiving an RF signal, an ultrasonic receiver receiving an ultrasonic signal, and a controller transmitting the RF signal to a beacon through the RF transceiver, receiving an RF response signal to the RF signal to calculate a distance between the mobile unit and the beacon based on the RF signal, and calculating a distance between the mobile unit and the beacon based on the ultrasonic signal when the ultrasonic signal, which is transmitted from the beacon together with the RF response signal, is received through the ultrasonic receiver.

### CROSS REFERENCE

This application claims priority under 35 U.S.C. §119 to Korean Patent Application No. 10-2008-0132320, filed on Dec. 23, 2008, the disclosure of which is incorporated herein by reference in its entirety.

### TECHNICAL FIELD

The present disclosure relates to a technology for estimating position of mobile unit, and more particularly, to an apparatus and method for estimating position of mobile unit, which measure distance by transmitting and receiving a signal between a beacon and a tag attached to the mobile unit to estimate the position of the mobile unit.

### BACKGROUND

A technology has been known for estimating the position of a mobile unit based on ultrasonic. For example, a tag attached to the mobile unit carries a beacon identifier to be called in a radio frequency (RF) sync signal to the outside. Furthermore, among beacons receiving the carried RF sync signal, a beacon having an identifier according with the beacon identifier carried in the RF sync signal transmits an ultrasonic signal to a tag. The tag receives the transmitted ultrasonic signal from a called beacon, and calculates an ultrasonic time-of-flight (TOF) from an RF sync time to the reception of an ultrasonic signal. When the ultrasonic TOF is t second, an ultrasonic distance-of-flight is expressed as Equation (1) below.

d=v×t (1)

where d is an ultrasonic distance-of-flight, and v is an ultrasonic speed-of-flight. The ultrasonic speed-of-flight is expressed as Equation (2) below.

v=331.5+0.6×T [m/sec]

where T is an air temperature [° C.].

FIG. 1 is a reference diagram for describing trilateration.

Referring to FIG. 1, two circles meet at two points in a plane. Accordingly, the two-dimensional coordinates (xᵣ, yᵣ) of a mobile unit are represented as a point at which three circles meet. To calculate the two-dimensional coordinates of the mobile unit, distances from three beacons to the mobile unit must be measured. When measuring distance with each beacon, speed of flight between an RF sync signal and the reception of ultrasonic is measured, and distances d1 to d3 are calculated through the above Equation (1). The position (xᵣ, yᵣ) of the mobile unit may be calculated through trilateration by using the coordinates of beacons b1 to b3 and the distances d1 to d3 from the each beacon to the mobile unit.

As described above, in a case where the distance between the mobile unit and the beacon is measured with ultrasonic, there are few distance errors. However, since the transmission speed of ultrasonic is slower than that of RF, the reception latency of the ultrasonic is relatively long. Accordingly, when measuring distance greater than 10 m with the ultrasonic, it is difficult to decrease time intervals at which the beacon is scanned. Due to this reason, when measuring a position with the ultrasonic, it is difficult to position a beacon interval of 10 m or greater. In particularly, when tracking the position of the mobile unit with the ultrasonic in an outdoor wide space, very many beacons must be disposed.

This work was supported by the IT R&D program of MKE/IITA.

[2008-S033-01, Development of Global Seamless Localization Sensor]

### SUMMARY OF THE INVENTION

Accordingly, the present disclosure provides an apparatus and method for estimating position of mobile unit, which can minimize the estimation position error of a mobile unit even while increasing the positioning interval of a beacon.

According to an aspect, there is provided a tag attached to a mobile unit to estimate a position of the mobile unit, the tag including: a radio frequency (RF) transceiver transmitting and receiving an RF signal; an ultrasonic receiver receiving an ultrasonic signal; and a controller transmitting the RF signal to a beacon through the RF transceiver, receiving an RF response signal to the RF signal to calculate a distance between the mobile unit and the beacon based on the RF signal, and calculating a distance between the mobile unit and the beacon based on the ultrasonic signal when the ultrasonic signal, which is transmitted from the beacon together with the RF response signal, is received through the ultrasonic receiver.

According to another aspect, there is provided a beacon for estimating a position of a mobile unit through communication with a tag attached to the mobile unit, the beacon including: an RF transceiver transmitting and receiving an RF signal; an ultrasonic transmitter transmitting an ultrasonic signal; and a controller transmitting an RF response signal to the tag through the RF transceiver, and transmitting the ultrasonic signal to the tag through the ultrasonic transmitter, when the RF signal transmitted from the tag is received through the RF transceiver.

According to another embodiment, there is provided a method for estimating a position of a mobile unit in a tag attached to the mobile unit, the method including: transmitting an RF signal to the outside; receiving an RF response signal transmitted from the beacon receiving the transmitted RF signal; calculating a distance between the mobile unit and the beacon based on the RF signal through a reception point of the RF response signal from a transmission point of the RF signal; checking whether an ultrasonic signal, which is transmitted from the beacon together with the RF response signal, is received; and measuring a Time-of-Flight (TOF) of the ultrasonic signal, and calculating a distance between the mobile unit and the beacon based on the ultrasonic signal by using the measured TOF, when the ultrasonic signal is received.

According to another embodiment, there is provided a method for estimating a position of a mobile unit in a beacon, the method including: receiving an RF signal transmitted from a tag attached to the mobile unit; and transmitting an RF response signal and an ultrasonic signal to the tag in response to the received RF signal.

According to another embodiment, there is provided a method for estimating a position of a mobile unit in a tag attached to the mobile unit, the method including: transmitting an RF signal and an ultrasonic signal to the outside for estimating the position of the mobile unit; receiving an RF response signal transmitted from the beacon receiving the transmitted RF signal; and calculating a distance between the mobile unit and the beacon based on the RF signal through a reception point of the RF response signal from a transmission point of the RF signal.

According to another embodiment, there is provided a method for estimating a position of a mobile unit in a beacon, the method including: receiving an RF signal transmitted from a tag attached to the mobile unit for the position estimation of the mobile unit; transmitting, by the tag, an RF response signal to the tag in response to the received RF signal in order to calculate a distance between the mobile unit and the tag based on the RF signal with a round trip time of the RF signal; driving a timer at a reception point of the RF signal; stopping the timer at a reception point of an ultrasonic signal, when the ultrasonic signal, which is transmitted from the tag together with the RF signal, is received; and calculating a distance between the mobile unit and the beacon based on the ultrasonic signal by using a driving time of the timer being a TOF of the received ultrasonic signal.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a reference diagram for describing trilateration;

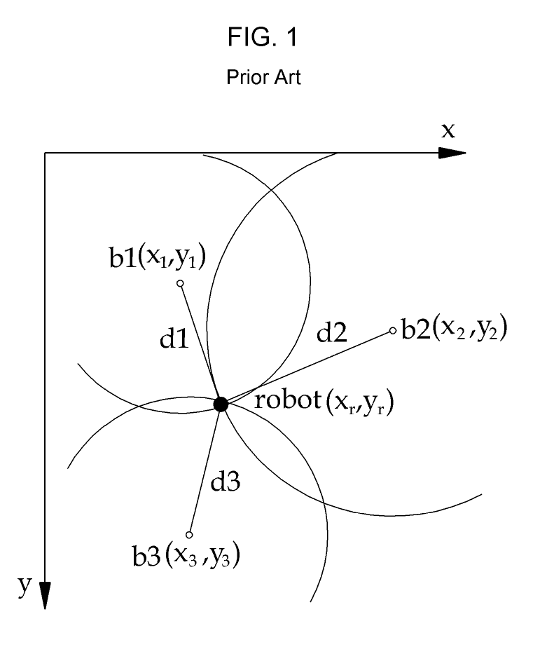

FIG. 2 is a block diagram of a tag and beacon according to an embodiment of the present invention;

FIG. 3 is a flowchart illustrating the position estimation of a mobile unit performed in the tag of FIG. 2;

FIG. 4 is a flowchart illustrating the position estimation of the mobile unit performed in the beacon of FIG. 2;

FIG. 5 is a block diagram of a tag and beacon according to another embodiment of the present invention;

FIG. 6 is a flowchart illustrating the position estimation of the mobile unit performed in the tag of FIG. 5; and

FIG. 7 is a flowchart illustrating the position estimation of the mobile unit performed in the beacon of FIG. 5.

### DETAILED DESCRIPTION OF EMBODIMENTS

Hereinafter, specific embodiments will be described in detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

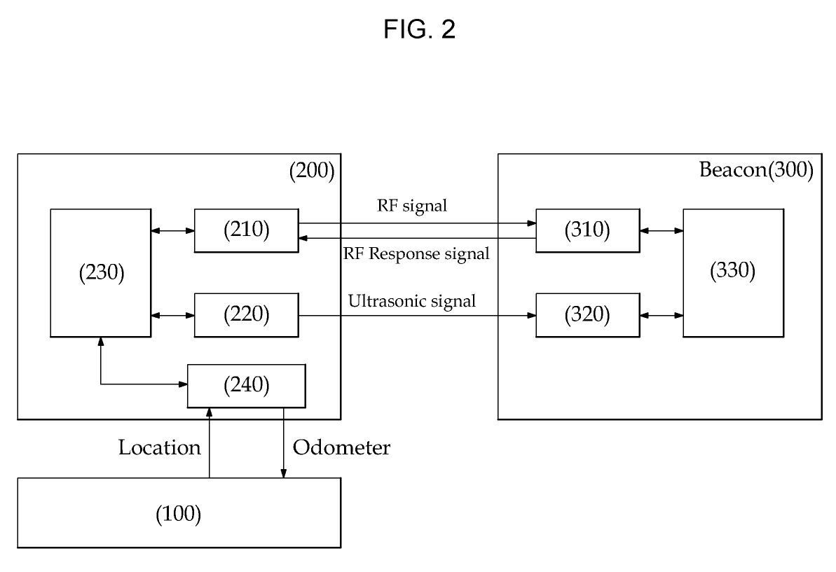

FIG. 2 is a block diagram of a tag and beacon according to an embodiment of the present invention.

Referring to FIG. 2, a tag 200 is an element which is attached to a mobile unit 100 and estimates its position. The tag 200 includes a radio frequency (RF) transceiver 210, an ultrasonic receiver 220, and a controller 230. The RF transceiver 210 is an element for transmitting and receiving an RF signal with a beacon 300. The ultrasonic receiver 220 is an element for receiving ultrasonic transmitted from the beacon 300. The controller 230 is an element for controlling the overall operation of the tag 200, and may be a micro control unit. The controller 230 executes a software algorithm for estimating the position of the mobile unit 100.

The controller 230 transmits an RF signal to the outside through the RF transceiver 210. The RF signal is a signal for synchronization in order for the beacon to transmit an ultrasonic signal, and also is a signal for measuring the distance between the mobile unit 100 and the beacon 300. In an embodiment of the present invention, the controller 230 carries a beacon ID to be called in the RF signal to the outside through the RF transceiver 210. Subsequently, the RF transceiver 210 receives an RF response signal, which is transmitted from the beacon 300, through the RF transceiver 210, and the controller 230 measures the round trip time of the RF signal from the point at which the RF response signal is received from the transmission point of the RF signal. The distance between the mobile unit 100 and the beacon 300 may be calculated by measuring the RF round trip time. A scheme of calculating the distance between a mobile unit and a beacon based on RF has been well known.

After the reception of the RF response signal, the ultrasonic receiver 220 receives an ultrasonic signal which is transmitted from the beacon 300 together with the RF response signal. The controller 230 measures the TOF of the ultrasonic signal received through the ultrasonic receiver 220. In an embodiment of the present invention, the controller 230 may measure the TOF of the ultrasonic signal from the point at which the ultrasonic signal is received from the transmission point of the RF signal. In another embodiment of the present invention, the controller 230 may measure the TOF of the ultrasonic signal from the point at which the ultrasonic signal is received from the reception point of the RF response signal. The difference between the transmission point of the RF signal and the reception point of the RF response signal is very small because the speed of RF is far faster than that of ultrasonic, and thus, in measuring the TOF of the ultrasonic, an initial point may be the transmission point of the RF signal or the reception point of the RF response signal.

The controller 230 corrects a distance data (hereinafter, referred to as ultrasonic distance data) between the mobile unit 100 and the beacon 300, which is calculated based on the ultrasonic, with a distance data (hereinafter, referred to as RF distance data) between the mobile unit 100 and the beacon 300 which is calculated based on RF. In an embodiment of the present invention, the RF distance data may be replaced with the ultrasonic distance data.

The beacon 300 includes an RF transceiver 310, an ultrasonic transmitter 320, and a controller 330. The RF transceiver 310 is an element for transmitting and receiving an RF signal with the tag 200. The ultrasonic transmitter 320 is an element for transmitting ultrasonic to the tag 200. The controller 330 is a control unit for controlling the overall operation of the tag 200, and performs an operation for estimating the position of the mobile unit 100. The controller 330 checks a beacon ID carried in an RF signal received through the RF transceiver 310, and transmits an RF response signal to the tag 200 through the RF transceiver 310 when the beacon ID is the same as its own identifier. Moreover, the controller 330 transmits an ultrasonic signal through the ultrasonic transmitter 320 together with the transmission of the RF response signal.

As described above, when the RF signal is used as a signal for distance measurement as well as the sync signal of ultrasonic, the positioning interval of a beacon can be increased. When the positioning interval of the beacon is increased, the disposition of a wide region can be detected even with the less number of beacons. However, when a distance is measured with RF, a position error is larger than when the distance is measured with ultrasonic. This limitation is supplemented with a measurement distance by the ultrasonic.

For example, when the beacons are positioned at intervals of an ultrasonic transceivable distance or greater, a tag can receive ultrasonic signals transmitted from some beacons according to the position of a mobile unit. Accordingly, in a case where the ultrasonic signal is received, a corresponding RF distance data is corrected with an ultrasonic distance data. In this case, the distance error between the mobile unit and the beacon decreases, and consequently the error of the position estimation coordinates of the mobile unit is reduced through trilateration.

Moreover, in a case where the RF distance data cannot be corrected with the ultrasonic distance data, it may be corrected with the odometer of the mobile unit 100. For this, the tag 200 further includes a communication interface 240 for communication with the mobile unit 100. The interface scheme of the communication interface 240 is not limited.

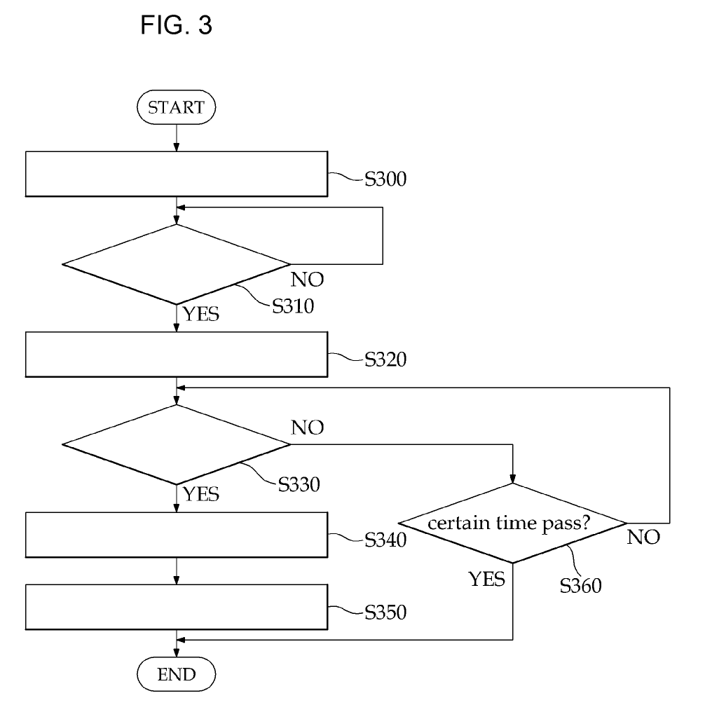

FIG. 3 is a flowchart illustrating the position estimation of the mobile unit performed in the tag of FIG. 2.

Referring to FIG. 3, the controller 230 transmits an RF signal for distance measurement and ultrasonic synchronization based on RF to the outside through the RF transceiver 210 in operation S300, and checks whether an RF response signal returned from the beacon 300 receiving the transmitted RF signal is received in operation S310. In operation S300, the controller 230 may carry the identifier of the beacon 300 to be called in the RF signal. When the RF response signal is received, the controller 230 measures the round trip time of the RF signal and calculates a distance based on RF between mobile unit 100 and the beacon 300 in operation S320. Subsequently, the controller 230 checks whether an ultrasonic signal transmitted from the beacon 300 is received in operation S330. Since the speed of ultrasonic is far slower than that of RF, the ultrasonic signal that is transmitted from the beacon 300 together with the RF response signal is received to later than the RF response signal in time.

When the ultrasonic signal is received, the controller 230 measures the TOF of the ultrasonic and calculates a distance based on the ultrasonic between the mobile unit 100 and the beacon 300 in operation S340. Subsequently, the RF distance data and the ultrasonic distance data are merged in operation S350. This means that the RF distance data is corrected to the RF distance data. In an embodiment of the present invention, in a case where the ultrasonic signal is received, the ultrasonic distance data instead of the RF distance data is adopted as the distance data between the mobile unit 100 and the beacon 300. On the other hand, when the ultrasonic signal is not received for a certain time, the controller 230 adopts the RF distance data calculated through operation S320 as the distance data between the mobile unit 100 and the beacon 300, or corrects the distance data with the odometer of the mobile unit 100.

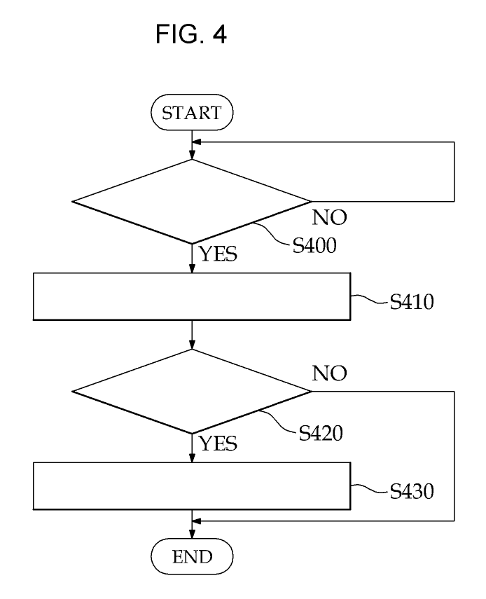

FIG. 4 is a flowchart illustrating the position estimation of the mobile unit performed in the beacon of FIG. 2

Referring to FIG. 2, when an RF signal is received through the RF transceiver 310 in operation S400, the controller 330 checks a beacon ID carried in the RF signal in operation S410, and determines whether the beacon ID is the same as its own identifier in operation S420. Herein, operations S410 and S420 may be omitted. The controller 330 transmits an RF response signal to the tag 200 through the RF transceiver 310, and simultaneously transmits an ultrasonic signal to the tag 200 through the ultrasonic transmitter 320 in operation S430. Herein, since the RF signal is a signal for distance measurement based on RF as well as the sync signal of ultrasonic, the controller 330 transmits the ultrasonic signal and simultaneously transmits the RF response signal.

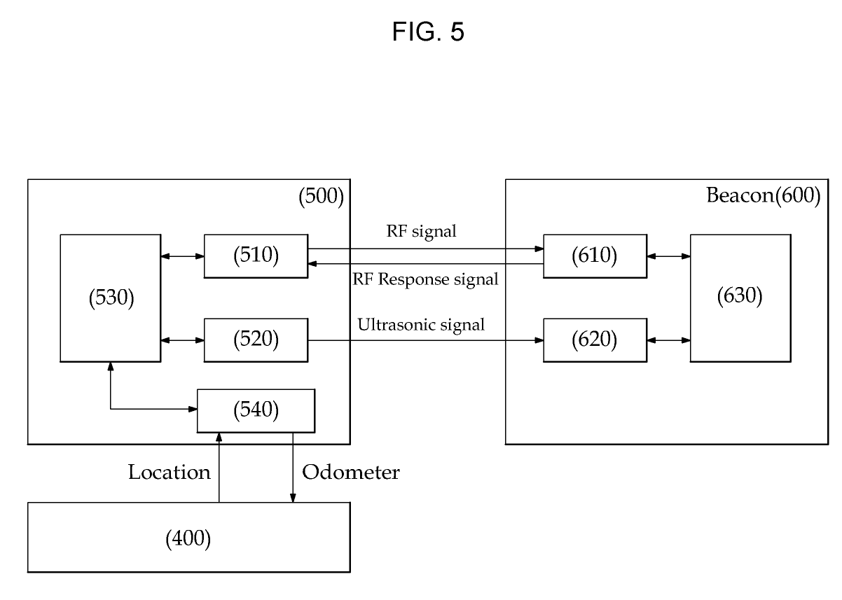

Unlike the above-described case, a tag may transmit ultrasonic at the same time with an RF signal. In this case, the tag calculates an RF distance data, and a beacon measures an ultrasonic TOF to calculate an ultrasonic distance data. When the beacon transmits the calculated ultrasonic distance data to the tag or the tag transmits the calculated RF distance data to the beacon, the RF distance data and the ultrasonic distance data may be merged in one of the beacon and the tag. In this case, as illustrated in FIG. 5, a tag 500 includes an RF transceiver 510, an ultrasonic transmitter 520, and a controller 530. A beacon 600 includes an RF transceiver 610, an ultrasonic receiver 620, and a controller 630. Herein, the tag 500 may further include a communication interface 540. Although the respective elements are referred to as different reference numerals, they may be the same as or similar to like terms with reference to FIG. 2.

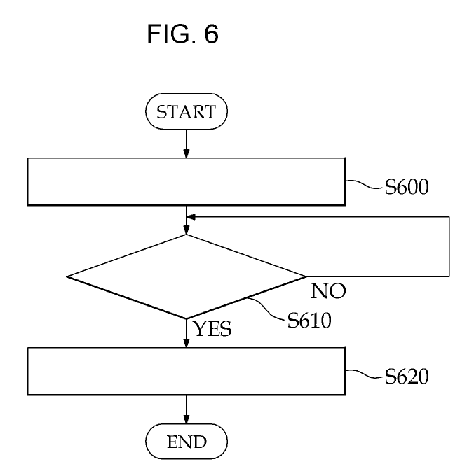

FIG. 6 is a flowchart illustrating the position estimation of the mobile unit performed in the tag of FIG. 5.

Referring to FIG. 6, the controller 530 respectively transmits an RF signal and an ultrasonic signal to the outside through the RF transceiver 510 and the ultrasonic transmitter 520 in operation S600. The RF signal is a signal for synchronization in order for the beacon 600 to transmit an ultrasonic signal, and also is a signal for measuring the distance between the mobile unit 400 and the beacon 600. The ultrasonic signal also is a signal for measuring the distance between the mobile unit 400 and the beacon 600. In an embodiment of the present invention, the controller 530 may carry a beacon ID to be called in the RF signal to the outside through the RF transceiver 510. Subsequently, the controller 530 checks whether an RF response signal transmitted from the beacon 600 is received through the RF transceiver 610 in operation S610. When the RF response signal is received through the RF transceiver 610, the controller 530 measures the round trip time of the RF signal from the point at which the RF response signal is received from the transmission point of the RF signal, and calculates an RF distance data in operation S620. Subsequently, although not shown, the controller 530 transmits the RF distance data to the beacon 600, or may receive the ultrasonic distance data from the beacon 600 to correct the RF distance data.

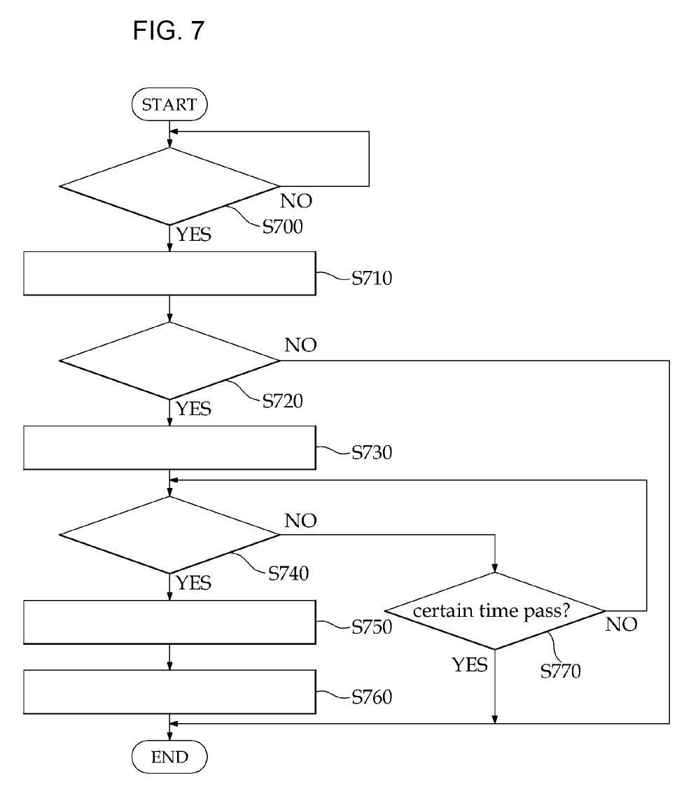

FIG. 7 is a flowchart illustrating the position estimation of the mobile unit performed in the beacon of FIG. 5.

Referring to FIG. 7, the controller 630 checks whether the RF signal is received through the RF transceiver 610 in operation S700. When the RF signal is received through the RF transceiver 610 as a result of the check, the controller 630 checks the beacon ID carried in the RF signal in operation S710, and determines whether the beacon ID is the same as its own ID in operation S720. Herein, operations S710 and S720 may be omitted. When the beacon ID is the same as the ID of the controller 630 as a result of the determination, the controller 630 transmits the RF response signal to the tag 500 through the RF transceiver 610, and drives a timer for measuring the TOF of the ultrasonic in operation S730. Subsequently, the controller 630 checks whether the ultrasonic signal is received through the ultrasonic receiver 620 in operation S740. When the ultrasonic signal is received through the ultrasonic receiver 620 as a result of the check, the controller 630 stops the timer in operation S750. The controller 630 calculates the ultrasonic distance data by using the driving time of the timer being the measured ultrasonic TOF in operation S760. Subsequently, although not shown, the controller 630 may transmit the ultrasonic distance data to the tag 500, or else the controller 630 may receive the RF distance data from the tag 500 and correct the error of the received RF distance data with the ultrasonic distance data.

Embodiments of the present invention simultaneously use the RF signal for distance measurement as well as ultrasonic signal synchronization, thereby positioning the beacons at wide intervals. Moreover, embodiments of the present invention can correct the error of RF distance measurement by ultrasonic distance measurement, and consequently enable to obtain a relative accurate distance data in an indoor/outdoor wide region.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A tag attached to a mobile unit to estimate a position of the mobile unit, the tag comprising:
a radio frequency (RF) transceiver transmitting and receiving an RF signal;
an ultrasonic receiver receiving an ultrasonic signal; and
a controller transmitting the RF signal to a beacon through the RF transceiver, receiving an RF response signal to the RF signal to calculate a distance between the mobile unit and the beacon based on the RF signal, and calculating a distance between the mobile unit and the beacon based on the ultrasonic signal when the ultrasonic signal, which is transmitted from the beacon together with the RF response signal, is received through the ultrasonic receiver.

2. The tag of claim 1, wherein the controller corrects a distance data between the mobile unit and the beacon based on the RF signal by using a distance data between the mobile unit and the beacon based on the ultrasonic signal.

3. The tag of claim 2, wherein the controller replaces the distance data between the mobile unit and the beacon based on the RF signal with the distance data between the mobile unit and the beacon based on the ultrasonic signal.

4. A beacon for estimating a position of a mobile unit through communication with a tag attached to the mobile unit, the beacon comprising:
a radio frequency (RF) transceiver transmitting and receiving an RF signal;
an ultrasonic transmitter transmitting an ultrasonic signal; and
a controller transmitting an RF response signal to the tag through the RF transceiver, and transmitting the ultrasonic signal to the tag through the ultrasonic transmitter, when the RF signal transmitted from the tag is received through the RF transceiver.

5. A method for estimating a position of a mobile unit in a tag attached to the mobile unit, the method comprising:
transmitting a radio frequency (RF) signal to the outside;
receiving an RF response signal transmitted from the beacon receiving the transmitted RF signal;
calculating a distance between the mobile unit and the beacon based on the RF signal through a reception point of the RF response signal from a transmission point of the RF signal;
checking whether an ultrasonic signal, which is transmitted from the beacon together with the RF response signal, is received; and
measuring a Time-of-Flight (TOF) of the ultrasonic signal, and calculating a distance between the mobile unit and the beacon based on the ultrasonic signal by using the measured TOF, when the ultrasonic signal is received.

6. The method of claim 5, wherein the transmitting of the RF signal comprises carrying a beacon identifier to be called in the RF signal to the outside.

7. The method of claim 5, further comprising correcting a distance data between the mobile unit and the beacon, which is calculated based on the RF signal, by using a distance data between the mobile unit and the beacon which is calculated based on the ultrasonic signal.

8. The method of claim 7, wherein the correcting of the distance data comprises replacing the distance data between the mobile unit and the beacon, which is calculated based on the RF signal, with the distance data between the mobile unit and the beacon which is calculated based on the ultrasonic signal.

9. A method for estimating a position of a mobile unit in a beacon, the method comprising:
receiving a radio frequency (RF) signal transmitted from a tag attached to the mobile unit; and
transmitting an RF response signal and an ultrasonic signal to the tag in response to the received RF signal.

10. A method for estimating a position of a mobile unit in a tag attached to the mobile unit, the method comprising:
transmitting a radio frequency (RF) signal and an ultrasonic signal to the outside for estimating the position of the mobile unit;
receiving an RF response signal transmitted from the beacon receiving the transmitted RF signal; and
calculating a distance between the mobile unit and the beacon based on the RF signal through a reception point of the RF response signal from a transmission point of the RF signal.

11. The method of claim 10, further comprising transmitting the calculated distance data to the beacon.

12. The method of claim 10, further comprising:
receiving, by the beacon, a distance data between the mobile unit and the beacon which is calculated based on the ultrasonic signal; and
correcting a distance data between the mobile unit and the beacon, which is calculated based on the RF signal, by using the distance data between the mobile unit and the beacon which is calculated based on the ultrasonic signal.

13. The method of claim 12, wherein the correcting of the distance data comprises replacing the distance data between the mobile unit and the beacon, which is calculated based on the RF signal, with the distance data between the mobile unit and the beacon which is calculated based on the ultrasonic signal.

14. A method for estimating a position of a mobile unit in a beacon, the method comprising:
receiving a radio frequency (RF) signal transmitted from a tag attached to the mobile unit for the position estimation of the mobile unit;
transmitting, by the tag, an RF response signal to the tag in response to the received RF signal in order to calculate a distance between the mobile unit and the tag based on the RF signal with a round trip time of the RF signal;
driving a timer at a reception point of the RF signal;
stopping the timer at a reception point of an ultrasonic signal, when the ultrasonic signal, which is transmitted from the tag together with the RF signal, is received; and
calculating a distance between the mobile unit and the beacon based on the ultrasonic signal by using a driving time of the timer being a Time-of-Flight (TOF) of the received ultrasonic signal.

15. The method of claim 14, further comprising transmitting a distance data, which is calculated based on the ultrasonic signal, to the tag.

16. The method of claim 15, further comprising:
receiving, by the tag, the distance data between the mobile unit and the beacon which is calculated based on the RF signal; and
correcting a distance data between the mobile unit and the beacon, which is calculated based on the RF signal, by using the distance data between the mobile unit and the beacon, when the ultrasonic signal is received.
